(19) United States
(12) Patent Application Publication
(10) Pub. No.: US 2002/0143656 A1
(43) Pub. Date: Oct. 3, 2002

(54) Method, system and program product for trading electronic products

(75) Inventors: Mie Matsuo, Kamakura-shi (JP); Nobuo Hayasaka, Yokosuka-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/092,529

(22) Filed: Mar. 8, 2002

(30) Foreign Application Priority Data
Mar. 30, 2001 (JP) 2001-099968

(51) Int. Cl. G06F 17/60

(52) U.S. Cl. 705/26

(57) ABSTRACT

There is provided a method for trading electronic products by transmitting/receiving electronic data by way of a communication network, the method comprising prompting an expected buyer of an electronic product to input a specification of the electronic product the expected buyer wants to buy, extracting the electronic product which meets the specification of the electronic product from a database, and outputting information of the electronic product to a manufacturer.

### CROSS-REFERENCE TO RELATED APPLICATIONS

This application is based upon and claims the benefit of priority from the prior Japanese Patent Application No. 2001-099968, filed on Mar. 30, 2001, the entire contents of which are incorporated herein by reference.

### BACKGROUND OF THE INVENTION

1. Field of the Invention

This invention relates to a method, a system and a program product for efficiently trading electronic products.

2. Description of the Related Art

Conventionally, when a customer wants to build a system by using several semiconductor chips (hardware IPs (IP: Intellectual Property)), the customer firstly examines specifications of the respective chips provided by semiconductor chip manufacturers. Then, the customer rearranges the specifications and estimates performance and cost of the chips on the basis of the rearranged specifications. However, this operation consumes much time and involves considerable cost. Additionally, the operation is performed on a man-to-man communication basis. As a result, it took massive labor costs, and the cost of the system has risen.

Additionally, simulation tools have to be introduced into the process of constructing the system in order to evaluate matching of different semiconductor chips and chip performance that can be obtained when chips are integrated. The introduction of these tools requires a large initial investment and professionals having the necessary professional knowledge. If outside agents are entrusted with construction of the simulation tools to prepare the simulation tools, it will also be an operation that consumes time and involves a large cost.

As pointed out above, any conventional system building process involves a large cost because the customer needs to evaluate performance of the system to be built by communicating with persons in charge at manufacturers of the semiconductor chips. Additionally, preparing simulation tools that can be used for the evaluation also consumes much time and involves a large cost.

### BRIEF SUMMARY OF THE INVENTION

In an aspect of the present invention, there is provided a method for trading electronic products by transmitting/receiving electronic data by way of a communication network, the method comprising: prompting an expected buyer of an electronic product to input a specification of the electronic product the expected buyer wants to buy; extracting the electronic product which meets the specification of the electronic product from a database; and outputting information of the electronic product to a manufacturer.

In another aspect of the invention, there is provided a system for trading electronic products by transmitting/receiving electronic data by way of a communication network, the system comprising: a first device configured to prompt an applicant who wants to buy an electronic product to input a specification of the electronic product the applicant wants to buy, and cause to extract the electronic product which meets the specification of the electronic product from a database; and a second device configured to output information of the electronic product to a manufacturer.

In still another aspect of the invention, there is provided a program product for causing a computer system to trade electronic products by way of a communication network, the program product comprising: a first program code recorded on a recording medium configured to assign the computer system a command for prompting an expected buyer of an electronic product to input a specification of the electronic product the expected buyer wants to buy; a second program code recorded on the recording medium configured to assign the computer system a command for extracting the electronic product which meets the specification of the electronic product from a database; and a third program code recorded on the recording medium configured to assign the computer system a command for outputting the information of the electronic product to a manufacturer.

In still another aspect of the invention, there is provided a method for trading electronic products by transmitting/receiving electronic data by way of a communication network, the method comprising: transmitting an retrieval program for retrieving an electronic product which meets a specification of the electronic product an expected buyer of the electronic product wants to buy to a terminal to prompt the terminal to start the retrieval program and transmit data which indicates a result of the retrieval including the specification of the electronic product; receiving data which indicates the result of the retrieval including the specification of the electronic product; and outputting information of the electronic product to a manufacturer based on the result of the retrieval.

### BRIEF DESCRIPTION OF THE DRAWINGS

FIG. 1 is a schematic block diagram illustrating the network configuration of one embodiment of a system for trading electronic products.

FIG. 2 is a detailed schematic block diagram of a system administration server that can be used for the embodiment.

FIG. 3 is a schematic illustration of the sequence of a method for trading electronic products that can be used with the embodiment when no simulation is performed.

FIG. 4 is a schematic illustration of the sequence of a method for trading electronic products that can be used with the embodiment when simulations are performed.

FIG. 5 is a schematic illustration of a display screen image for product retrieval that can be used for the embodiment.

FIG. 6 is a schematic illustration of a display screen image for selecting specification that can be used for the embodiment.

FIG. 7 is a schematic illustration of a display screen image for package/assembly retrieval that can be used for the embodiment.

FIG. 8 is a schematic illustration of an order placement procedure involving an auction that can be used for the embodiment.

FIG. 9 is a schematic illustration of another order placement procedure involving an auction that can be used for the embodiment.

FIG. 10 is a schematic illustration of still another order placement procedure involving an auction that can be used for the embodiment.

FIG. 11 is a schematic block diagram illustrating the network configuration for external design competition of one embodiment of the present invention where manufactures are not consistent with external design factories.

FIG. 12 is a schematic illustration of external design order placement procedure that can be used for a modified example of the embodiment.

FIG. 13 is a schematic illustration of the sequence of a method for trading electronic products that can be used for the modified example of the embodiment.

### DETAILED DESCRIPTION OF THE INVENTION

One embodiment of the invention will now be described in greater detail by referring to the accompanying drawings that illustrate the embodiment of the invention.

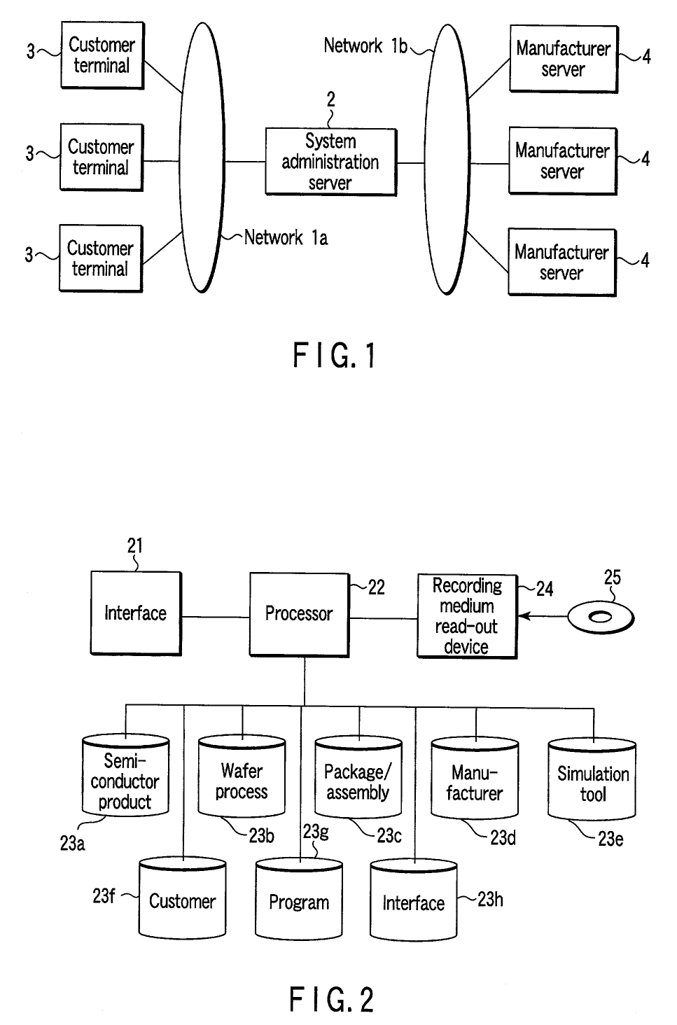

FIG. 1 is a schematic block diagram illustrating the network configuration of the embodiment of a system for trading electronic product. As shown in FIG. 1, a plurality of customer terminals 3 are connected to a system administration server 2 by way of a communication network 1a such as Internet and the like. Thus, the customer terminals 3 and the system administration server 2 can exchange data by way of the network 1a. Additionally, the system administration server 2 is connected to a plurality of manufacturer servers 4 also by way of a communication network 1b such as Internet and the like. Therefore, the system administration server 2 and the manufacturer servers 4 can exchange data by way of the network 1b. Note that the embodiment will be described below in terms of an instance where it is applied to a system for manufacturing semiconductor products which are examples of electronic products.

FIG. 2 is a detailed schematic block diagram of the system administration server 2 that can be used for the embodiment.

As shown in FIG. 2, the system administration server 2 has an interface 21 for controlling the exchange of information with the network 1a and 1b and a processor 22 connected to the interface 21 and adapted to execute various processing related to trading semiconductor products for the purpose of the embodiment of the invention.

The processor 22 is connected to a semiconductor product database 23a, a wafer process database 23b, a package/assembly database 23c, a manufacturer database 23d, a simulation tool database 23e, a customer database 23f, a program database 23g, and an interface database 23h.

The semiconductor product database 23a stores information on semiconductor products. The wafer process database 23b stores information on wafer processes for manufacturing the semiconductor products. The package/assembly database 23c stores information on packages/assemblies of the semiconductor products. The manufacturer database 23d stores information on manufacturers in which manufacturer information can be identified for each manufacturer. The simulation tool database 23e stores various simulation tools. The customer database 23f stores information on customers which can be identified for each customer. The program database 23g stores various programs for executing various processing necessary for trading the semiconductor products for the purpose of the embodiment of the invention. The interface database 23h stores information for specifying interfaces between electronic components, which are integrated into the semiconductor product. The electronic components are elements of the semiconductor product. Of course, the electronic components may be semiconductor components.

The semiconductor product database 23a stores information on specific products such as memories, logic products and system LSIs to be traded on a type in which the type of the product can be classified. Memories may include DRAMs, SRAMs and ROMs and logic products may include controller ICs, semi-custom ICs, full-custom ICs and communication ICs. The semiconductor product database 23a stores not only information on such specific products but also information on semiconductor products classified by specifications such as frequency bands of semiconductor products as parameters.

The wafer process database 23b stores information for specifying wafer processes by parameters such as micron dimensions (0.25 μm, 0.18 μm, . . . ), wafer types (Si, GaAs, SiGe, . . . ), wafer bore diameters (5-inch, 6-inch, 8-inch, . . . ), gate structures, wiring materials (Al, Cu, . . . ) and insulating film materials (SiO₂, low dielectric constant materials, . . . ).

The package/assembly database 23c stores information for specifying packages and assemblies by parameters such as sizes, external forms (BGA, DIP, QFP, . . . ), package types (single package or multi-package), package structures (single layer, multilayer (three-dimensional)), inner lead bonding modes (C4, TAB, wire) and packing types for shipment.

The simulation tool database 23e stores information on simulation tools such as a frequency performance simulation program, a cost simulation program, an outer dimension simulation program, an interface matching simulation program and a delivery date simulation program.

The frequency performance simulation program computationally determines the anticipated frequency performance by means of electromagnetic field analysis simulation, process analysis simulation, and circuit analysis simulation.

The cost simulation program calculates the anticipated cost of a system typically by using parameters such as the processes and the manufacturers involved in the system and the scale of the system.

The outer dimension simulation program outputs the anticipated outer dimensions of a system typically by using parameters such as outer dimension types, the processes and the manufacturers involved in the system.

The interface matching simulation program calculates and outputs information indicating whether interfaces between electronic components, which are integrated into the semiconductor product, are matched or not. Additionally, the interface matching simulation program outputs information on electronic component being required to matching interface with another electronic component. The interface matching simulation program is effective for trading the semiconductor products comprising a plurality of electronic components, such as system LSIs.

A delivery date simulation program outputs the anticipated delivery date by using parameters such as the processes and the manufacturers involved in the system and the scale of the system.

As any of the simulation programs are read out from the simulation database 23e by the processor 22. As a result, the processor 22 operates as a simulator.

The interface database 23h stores information for specifying interfaces between electronic components by parameters such as interface types which are selected by customers and the like (operating voltage, operating frequency, signal types (light, electricity, . . . ), . . . ).

Note that, unless specifically described otherwise, various processing of the embodiment are performed as the related programs are read out from the program database 23g and executed by the processor 22. Alternatively, a computer readable recording medium read-out device 24 connected to the processor 22 may read out programs which is recorded in a computer readable recording medium 25, and the processor 22 may execute the read out programs. Additionally, once the processor 22 may store the read-out programs in the program database 23g, and the processor 22 may read out the programs again to start the programs. In this case, a plurality of program codes configured to assign a computer system a command for executing various processing in the embodiment are recorded on the computer readable recording medium 25.

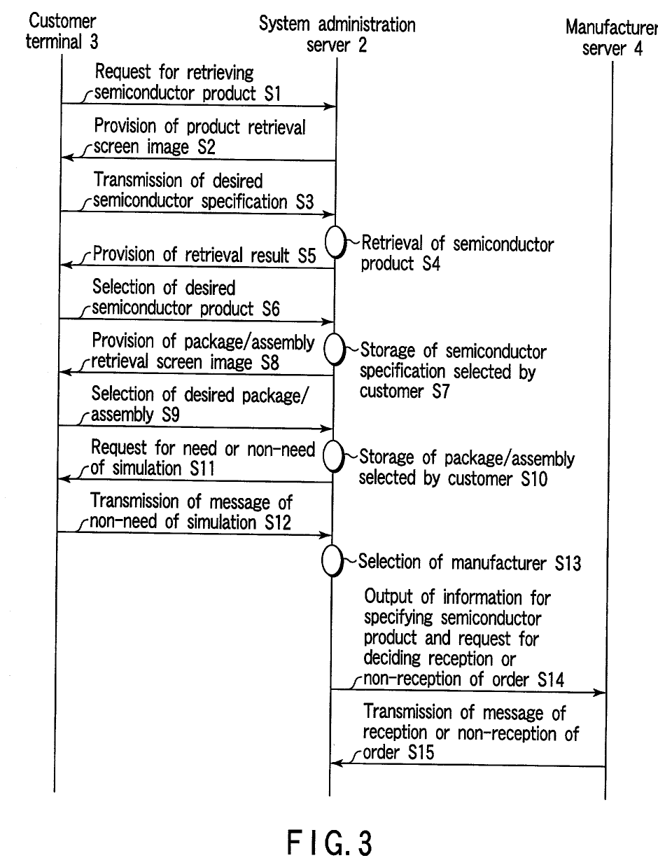

A method that can be used for the embodiment of the system for trading electronic products will now be described by referring to FIG. 3 which schematically illustrates the process sequence of the method. Note that, unless specifically described otherwise, the customer terminals 3, the system administration server 2 and the manufacturer servers 4 exchange information as they transmit and receive data by way of the network 1a or the network 1b.

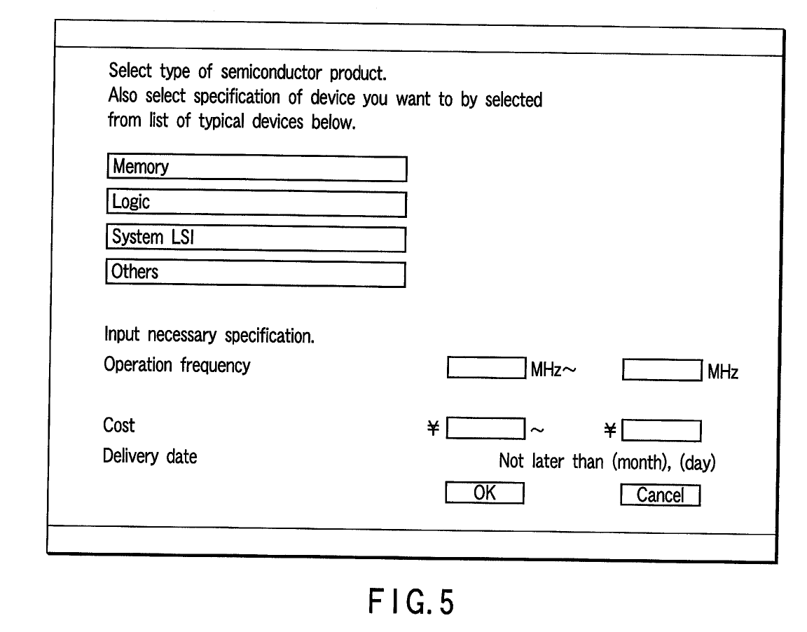

Referring to FIG. 3, first, a customer accesses the system administration server 2 by way of the customer terminal 3 and requests the retrieval of a semiconductor product the customer wants to purchase (s1). In response to the retrieval request, the system administration server 2 starts the product retrieval program and causes the display device (not shown) of the customer terminal 3 to display a product retrieval screen image (s2). FIG. 5 is a schematic illustration of a display screen image for product retrieval that can be used for the embodiment. Then, the customer is prompted to input the specification, cost and delivery date of the semiconductor product through the displayed screen image.

The specification of the semiconductor product may typically include information to classify the semiconductor product, performance of the semiconductor product (such as a frequency band), operating environment of the semiconductor product, and external design information. The specification, cost and delivery date of the semiconductor product input by the customer are transmitted from the customer terminal 3 to the system administration server 2 (s3). Then, the system administration server 2 detects one or more semiconductor products that satisfy the specification of the semiconductor product received from the customer terminal 3 (s4). The detection is performed by retrieving data from the semiconductor product database 23a. Then, the system administration server 2 provides the customer terminal 3 with information on at least one specific specification of the semiconductor product which meets the customer's satisfaction. If the semiconductor product comprises a plurality of semiconductor components and the plurality of semiconductor components are integrated into the semiconductor product, information on the specific specification of the semiconductor products which is provided to the customer terminal 3 may include information on the specification of the plurality of semiconductor components. Then, the system administration server 2 causes the display device (not shown) of the customer terminal 3 to display the information on the specification and prompt the customer to select one of the specifications (s5).

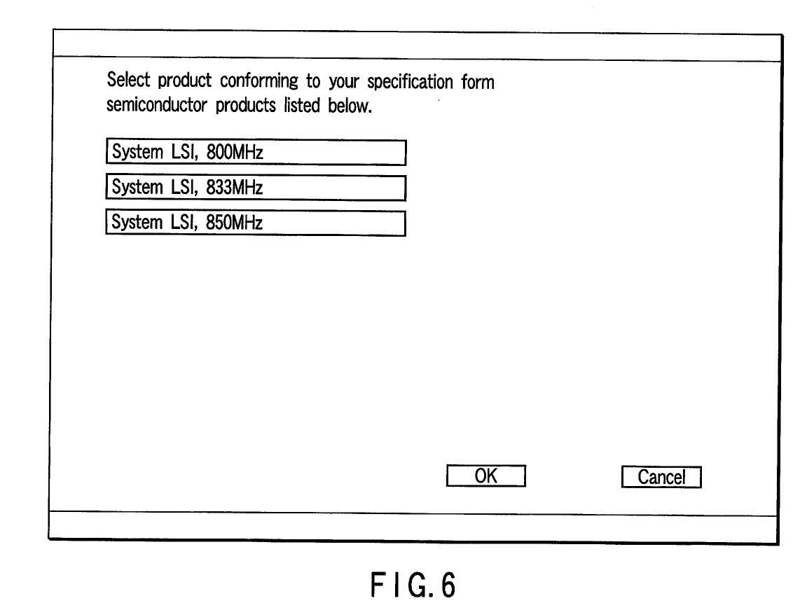

FIG. 6 schematically illustrates a display screen image for specification selection that can be used for the embodiment. Then, the customer will select one of the specifications displayed on the display device. If the specification transmitted from the customer is unequivocally defined, the customer may simply be asked if the customer accepts the displayed specification. The specification of the semiconductor product selected by the customer is transmitted to the system administration server 2 (s6). Thus, the processor 22 of the system administration server 2 stores the specification, the cost and the delivery date of the semiconductor product received from the customer terminal 3 in the customer database 23f (s7).

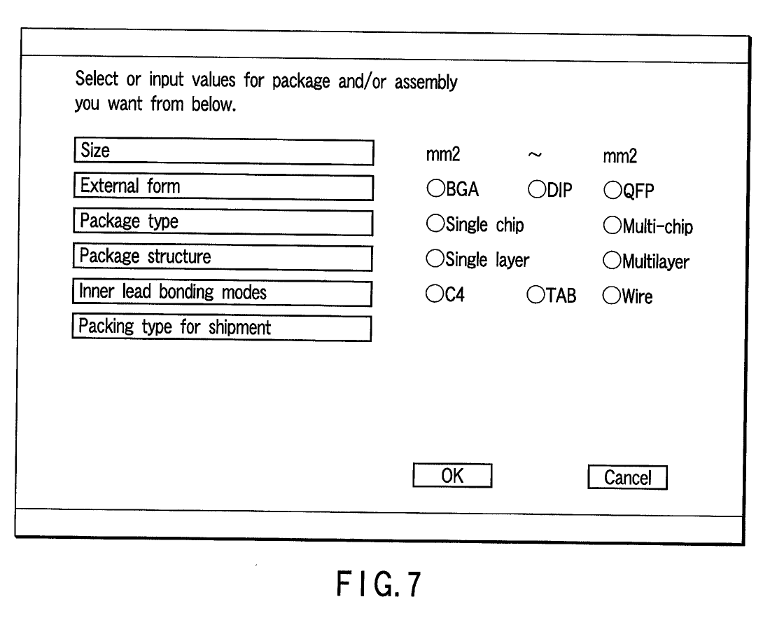

Thereafter, the system administration server 2 starts the package/assembly retrieval program and causes the display device (not shown) of the customer terminal 3 to display a package/assembly retrieval screen image (s8). FIG. 7 schematically illustrates a display screen image for package/assembly retrieval that can be used for the embodiment. The customer selects the package/assembly that satisfy the customer from the displayed screen image. Information on the package/assembly of the semiconductor product the customer wants to buy is transmitted from the customer terminal 3 to the system administration server 2 (s9). Then, the system administration server 2 determines if the received information on the package/assembly of the semiconductor product matches the semiconductor product specified in (s6) or not by reading the customer database 23f. If they do not match, the system administration server 2 prompts the customer to make another round of selection.

It may be appreciated that only the packages/assemblies that meet the specification of the semiconductor product provided by the customer may be displayed in the step (s8) for selection. In this case, the system administration server 2 compares the specifications of the semiconductor products read from the package/assembly database 23c and the data specified by the customer in advance and retrieves only the specifications that meet the requirements of the data or the condition specified by the customer. If the system administration server 2 determines that the information on the package/assembly received from the customer terminal 3 meets the specification specified by the customer in advance, the information on the package/assembly provided by the customer terminal 3 is stored in the customer database 23f (s10).

In this way, the specification and the package/assembly of the semiconductor product to be transacted between the system administration side and the customer side are identified.

Then, the system administration server 2 asks the customer terminal 3 if the customer wants a simulation of the selected semiconductor product or not (s11).

If the customer does not want any simulation and tells the system administration server 2 so by way of the customer terminal 3 (s12), the system administration server 2 selects the manufacturer with whom to place the order for manufacturing the product on the basis of the semiconductor product information including the specification, the cost and the delivery date and the package/assembly information (s13). It is preferable that the manufacturer is selected, on the basis of the data on the manufacturers provided in advance and stored in the manufacturer database 23d, by determining who can fabricate the semiconductor product.

The data on the manufacturers include facilities, manufacturing conditions and estimated results for manufacturing the semiconductor product. As the manufacturer with whom the order for manufacturing the semiconductor product is to be placed is selected, the semiconductor product information to be manufactured is read from the customer database 23f. Then, the interface 21 output the semiconductor product information to the manufacturer server 4 controlled by the selected manufacturer to prompt the manufacturer to answer if the manufacturer can receive an order of the semiconductor product which is specified by the received semiconductor product information or not (s14).

Then, the manufacturer determines if the manufacturer wants to receive the order or not on the basis of the semiconductor product information shown in the screen image on the display device (not shown) of the manufacturer server 4. Data indicating the determination result is transmitted to the system administration server 2 (s15). If the system administration server 2 receives the data indicating that the manufacturer wants to receive the order, the system administration server 2 actually places the order with the manufacturer. It may alternatively be so arranged that the system administration server 2 determines that the formal order of the semiconductor product is placed with the manufacturer when the system administration server 2 receives the data indicating that the manufacturer wants to receive the order.

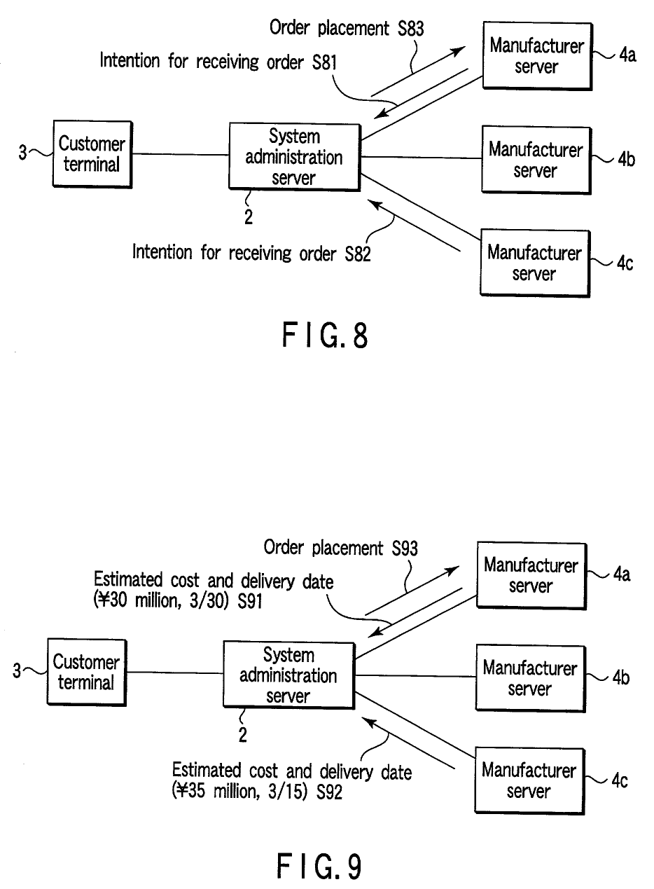

The request for manufacturing the semiconductor product may be sent to a plurality of manufacturers. If the request is sent to the manufacturers, it is preferable to adopt an auction by means of the network by following an auction procedure. FIGS. 8 and 9 schematically illustrate two possible order placement procedures involving an auction that can be used for the embodiment.

FIG. 8 is a schematic illustration of an order placement procedure involving an auction to decide a manufacture to be ordered based on timing of indicating intention for receiving the order. Assume that the request for manufacturing the semiconductor product is sent from the system administration server 2 to three manufacturer servers 4a, 4b, 4c and the system administration server 2 receives a response from the manufacturer server 4a first and then from the manufacturer server 4c, telling that they want to receive the order ((s81), (s82)). In this case, the order is placed with the manufacturer server 4a that responded first (s83).

FIG. 9 is a schematic illustration of an order placement procedure involving an auction based on estimated results provided by the manufacturer servers. Assume that the request for manufacturing the semiconductor product and providing information on the estimated result of the product is sent from the system administration server 2 to three manufacturer servers 4a, 4b, 4c and the system administration server 2 receives two estimated results respectively from the two manufacturer servers 4a, 4c ((s91), (s92)). Also assume that the estimated cost contained in the estimated result provided by the manufacturer server 4a is 300 millions yen and the estimated cost contained in the estimated result provided by the manufacturer server 4c is 350 millions yen. Then, the order is placed with the manufacturer server 4a whose estimated cost is lower (s93). It may alternatively be so arranged that, if the delivery date contained in the estimated result provided by the manufacturer server 4c is earlier than the delivery date contained in the estimated result provided by the manufacturer server 4a, the order is placed with the manufacturer server 4c.

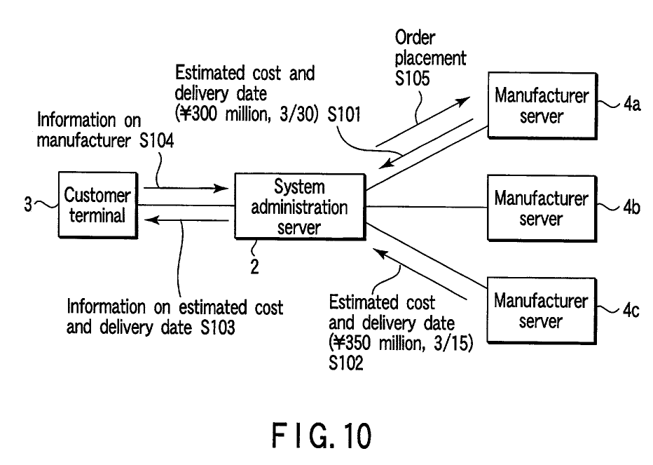

FIG. 10 is a schematic illustration of still another order placement procedure involving an auction in which the customer can select the manufacturer. Referring to FIG. 10, the system administration server 2 receives information on estimated results respectively from the manufacturer servers 4a, 4c ((s101) and (s102)). Then, the system administration server 2 transmits the information to the customer terminal 3 (s103) to prompt the customer to select the manufacturer. In this case, the system administration server 2 receives information on the selected manufacturer (e.g., the manufacturer 4a) from the customer terminal 3 (s104) and subsequently places the order with the server 4a of the selected manufacturer (s105).

Preferably, the system administration server 2 is connected to the fabrication factory server of each of the manufacturers including a database which stores information on the semiconductor manufacturing status such as the current status of lots of the semiconductor production equipment used by the manufacturer. Whenever necessary, the system administration server 2 can access the database of any of the candidate manufacturers to grasp the current status of the manufacturing status such as the status of the lots being manufactured in the fabrication factory. Then, the system administration server 2 can compute the period that can be used for manufacturing the semiconductor product. As a result of this, the system administration server 2 can computationally estimate the possible delivery date to make selection of a manufacturer and order placement much easier.

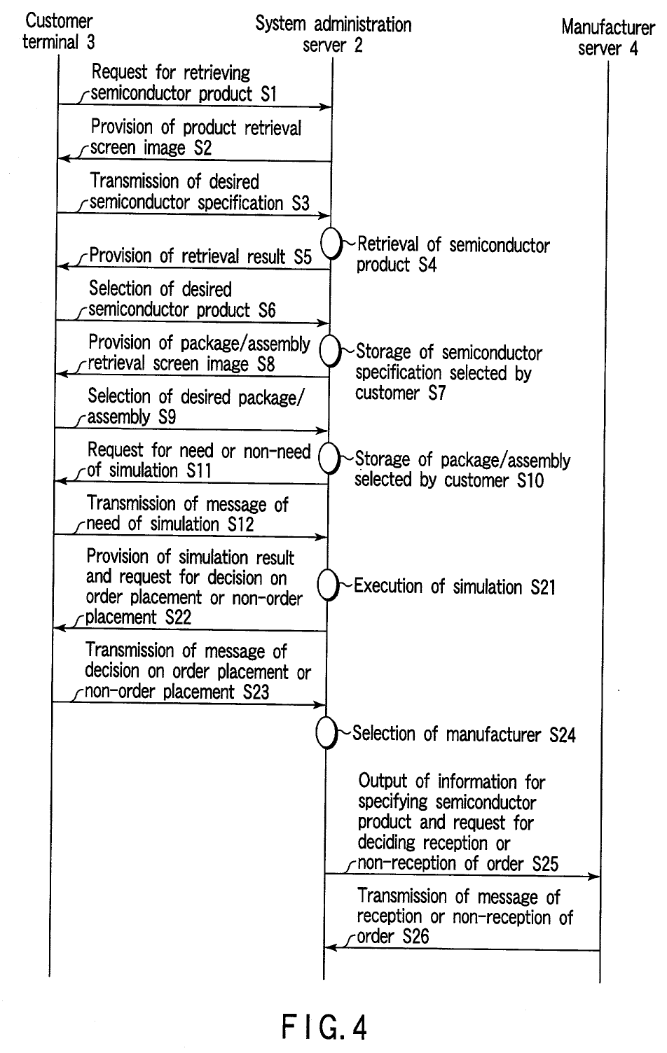

When it is found that information sent from the customer terminal 3 which indicates that the customer wants simulations in (s12), the system administration server 2 reads out the simulation tools stored in the simulation tool database 23e as shown in FIG. 4 and executes the programs for a frequency performance simulation, a cost simulation, an outer dimension simulation, an interface matching simulation and a delivery date simulation and so on (s21).

For example, the semiconductor product to be manufactured will be designed by the frequency performance simulation. The operation of designing the semiconductor product may typically proceed in a manner as described below. Firstly, a functional diagram and a circuit diagram of the semiconductor product are designed. Then, an automatic placement and routing (P & R: Placement & Routing) operation is conducted on the basis of the obtained functional diagram and circuit diagram. That is, the placement such as wiring on the actual product is automatically conducted. A plurality of semiconductor circuit patterns can be obtained by the above described design procedure. Then, the design parameters (manufacturing conditions) including the operation frequency, the chip area, the power consumption rate, the need or non-need of preparing masks, the manufacturing cost and the manufacturing period are computed. The obtained design parameters are displayed on the display screen of the customer terminal 3 as a result of the simulation. The customer is requested to decide if the customer will place the order or not (s22). It is noted that the above simulation may include a hardware IP simulation, a firmware IP simulation and a software IP simulation. The customer determines whether to place an order or not based on the design parameters displayed on the display screen, and the data which indicates the determination result is transmitted to the system administration server 2 (s23).

When the system administration server 2 receives information on the decision on order placement, the system administration server 2 selects the manufacturer and requests the manufacturer to determine if the manufacturer will receives the order or not on the basis of the specification for manufacturing the semiconductor product as in steps (s13) and (s14) ((s24), (s25)). Then, the system administration server 2 receives information on the determination result indicating if the manufacturer receives the order or not from the manufacturer server 4 (s26).

If the system administration server 2 receives a message that the manufacturer does not want to receive the order, the system administration server 2 prompts the customer terminal 3 to input a semiconductor specification or a request for buying package/assembly as in steps (s2) through (s9).

While the system administration server 2 is adapted to compute two types of parameters including operational or functional parameters such as the operation frequency and power consumption rate, and manufacturing parameters such as the cost and the manufacturing period, and provide the customer terminal 3 with both types of the parameters in the above description, the embodiment of the present invention is not limited thereto. For example, the operational or functional parameters may be computed firstly by simulation and the result of the simulation may be provided first to the customer terminal 3. Then, the system administration server 2 may compute the manufacturing conditions such as the cost and manufacturing period and show them to the customer terminal 3 only when the customer terminal 3 wants to place an order in response to the results of the simulation. In this way, the system administration server 2 does not need to make a simulation of the semiconductor product when the customer does not want to place an order. As a result of this, the cost of administrating the trading system can be reduced.

As described above, with this embodiment, the customer can obtain a semiconductor product that the customer wants to buy only by identifying typical conditions for specifying all the aspects of the process from the process for designing to the process for manufacturing the semiconductor product including the specification, the design, the delivery date, and the manufacturing period, along with the specification of the semiconductor product, without being required for the customer to make simulations including that of the system designing by using simulation tools.

The present invention is not limited to the above described embodiment. For instance, while the above embodiment is described in terms of a semiconductor product, it is also applicable to trading the hardware IPs, the firmware IPs and the software IPs for manufacturing the semiconductor product. Also, for instance, it is also applicable to transacting electronic products other than semiconductor products.

For instance, it is also applicable to trading electronic products which are elements of a cellular phone such as RF (Radio Frequency) IC switches, power amplifiers, analog components, baseband ICs, memories (such as E²PROMs, Flash memories, SRAMs and the like), discrete products, LCD drivers. Additionally, printed circuit board on which these components such as RF IC switches and the like are mounted may be traded according to the above embodiment. Further, it is also applicable to trading electronic products which form the cellular phone such as liquid crystal panels, LEDs, condensers, SAW filters, quartz oscillators, antennas, voltage-controlled oscillators, connectors, batteries. Further, it is also applicable to trading all kinds of electronic products.

Additionally, not only information including an aspect of performance of the electronic products but information including an aspect of external design such as package design of the product may be traded according to the above embodiment. In this case, the external design of the electronic products may be included in the specification of the electronic products in the above embodiments. Additionally, it can be also applicable to external design competition on the communication network. In the design competition, the system administration server 2 may request or invite the public for external design factories to make design of the electronic products.

If the manufacturer is consistent with the design factory, the competition may be performed in accordance with the above embodiment shown in FIG. 9 or FIG. 10 and the like. In this case, the system administration server 2 receives estimated results for designing the product with design information such as package design from the manufacturer servers 4a to 4c. The system administration server 2 or the customer terminal 3 can determine whether the customer places an order of the design of the product or not based on the design information.

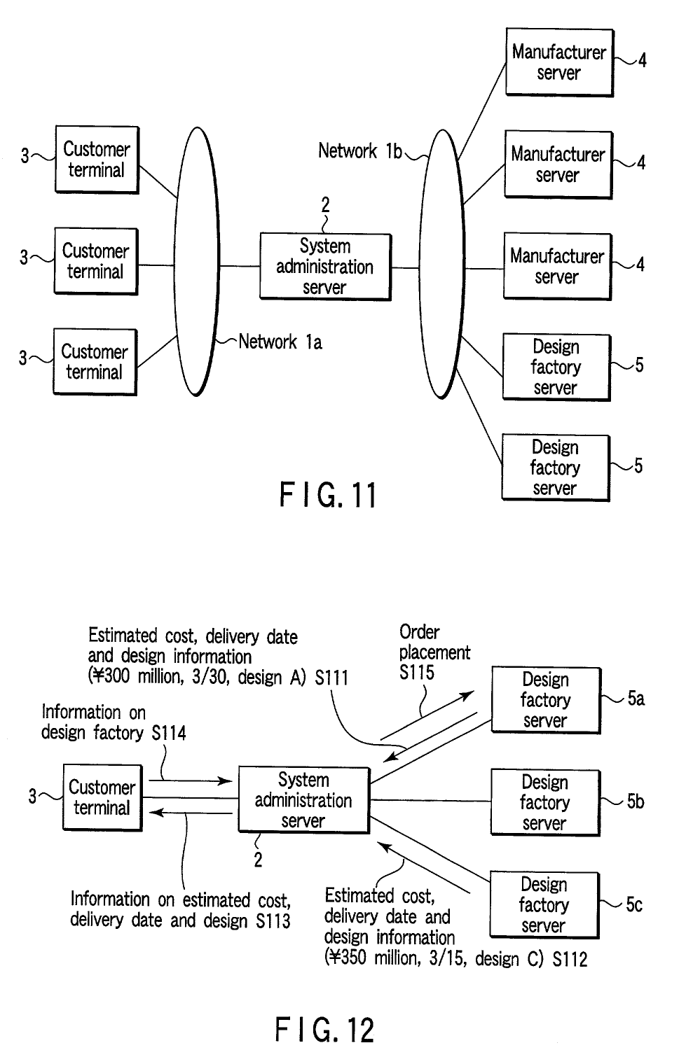

If the manufacturer is not consistent with the design factory, the system administration server 2 may request the design factories to design the product as well as the request for the manufacturers to provide the estimated result of the product. FIG. 11 is a schematic block diagram illustrating the network configuration where the manufacturer is not consistent with the design factory. Design factory servers 5 are connected to the system administration server 2 via the communication network 1b. FIG. 12 is a schematic illustration of the sequence of a method for trading electronic products that can be used with the embodiment. The processes shown in FIG. 12 are performed which are independent of the processes shown in FIG. 8 to FIG. 10.

Firstly, the system administration server 2 requests the design factory servers 5a to 5c to provide an estimated results including external design information such as package design. In this case, the system administration server 2 receives the estimated results including the design information from, for instance, the two design factory servers 5a, 5c who want to receive the order for designing the product ((s111), (s112)). Then, the system administration server 2 transmits the received information to the customer terminal 3 to prompt the customer terminal 3 to select the design factory the customer wants to place the order for designing the product. Then, the system administration server 2 receives the design factory information (for instance, the design factory of the design factory server 5a) (s114), and places the order for designing the product with the design factory server 5a (s115).

Additionally, electronic products for the trading may be comprised of a combination of a plurality of electronic components such as system LSIs. For instance, if the customer wants to combine a plurality of semiconductor chips or a plurality of IPs to form the system LSI, not only information on the specification of the system LSI itself but information on the specification of the semiconductor chips or the IPs is exchanged via the network 1a or 1b. Of course, electronic components may be traded according to the embodiment as well as the electronic products.

Still additionally, the processor 22 of the server 2 is made responsible for almost all the processing to be carried out in response to a request from one of the terminals 3 in the above description, it may alternatively be so arranged that the terminal 3 carries out some of the processing instead of the processor 22. In this case, the necessary programs may be stored on recording mediums and the recording mediums may be distributed to the respective terminals 3 or may be delivered to the terminals 3 by way of the network 1a without using recording mediums. The programs that the terminals 3 are required to execute may include one with which the customer inputs the specification of a semiconductor product or a package/assembly and transmits it to the server 2. Similarly, it may be so arranged that the manufacturer server 4 receives programs to be executed by it. The programs that the manufacturer server 4 is required to execute may include one with which the manufacturer server 4 prepares an estimated result in response to a request for providing the estimated result.

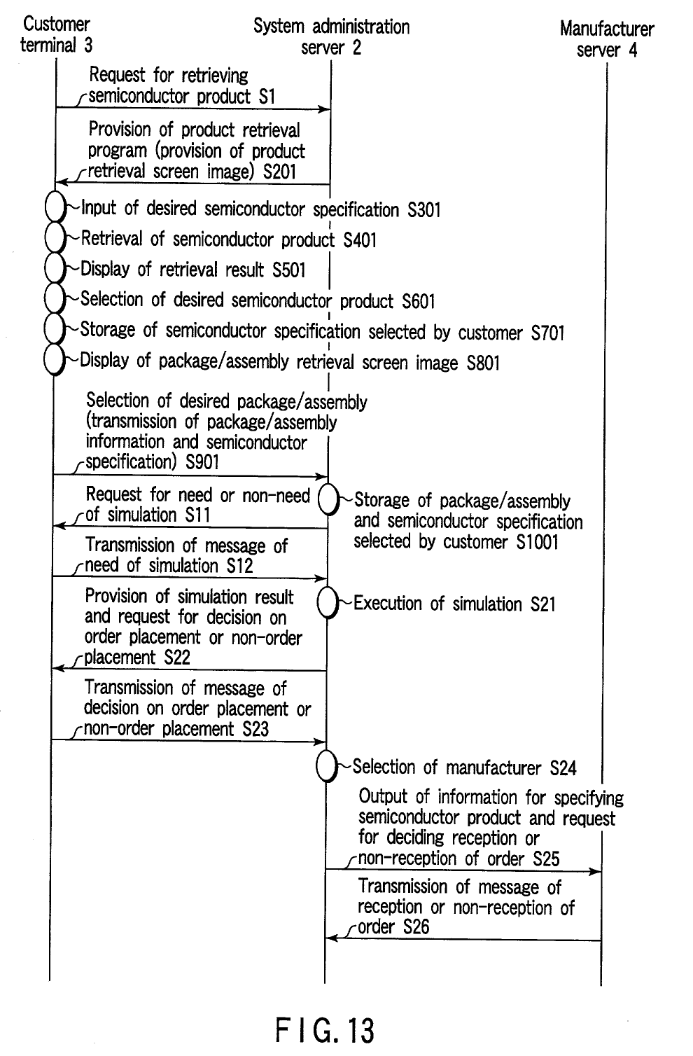

FIG. 13 schematically illustrates the sequence of operation of the customer terminal 3 when it carries out part of the processing of the system administration server 2. In FIG. 13, the steps (s1), (s11), (s12), (s21) through (s26) are common with the sequence of FIG. 4 and hence will not be described here any further. As shown in FIG. 13, the customer terminal 3 carries out processing of the decision of the semiconductor specification according to the program received from the system administration server 2.

Referring to FIG. 13, the system administration server 2 transmits the semiconductor product retrieval program (s201) in response to the request for retrieving a semiconductor product (s1). The customer terminal 3 receives the semiconductor product retrieval program and starts the program. A production retrieval image is displayed on the display device of the customer terminal 3. Followed by the instruction indicated in the production retrieval image, the customer inputs a desired semiconductor specification (s301). The product retrieval program in the customer terminal 3 executes a processing for retrieving the semiconductor products that conform to the semiconductor specification input by the customer (s401). The retrieval operation is same as (s4) in FIG. 4. Then, the result of the retrieval operation is displayed as a list on the display of the customer terminal 3 (s501). The displayed list is similar to the one displayed in (s5) of FIG. 4.

The customer selects one of the semiconductor products displayed in the list as a result of the retrieval operation (s601). The retrieval program stores the specification of the semiconductor product selected by the customer in the memory device of the customer terminal 3 (s701). Then, the retrieval program causes the customer terminal 3 to display a package/assembly list on the display of the customer terminal 3 (s801). The displayed list is similar to the one displayed in (s8) of FIG. 4. As the customer elects a desired package/assembly (s901), the information on the selected package/assembly and the semiconductor specification is transmitted to the system administration server 2. The system administration server 2 stores the received information (s1001). All the subsequent processing steps are same as the corresponding ones shown in FIG. 4. If a simulation is not conducted, the operation of steps (s11), (s12), and steps (s21) to (s26) is conducted as in FIG. 3.

While the system administration server 2 transmits the retrieval program to the customer terminal 3 and the customer terminal 3 carries out the processing for retrieving a semiconductor specification in FIG. 13, the embodiment of the present invention is not limited thereto. For example, the system administration server 2 may transmits predetermined programs to the customer terminal 3 to cause the terminal 3 to carry out the processing corresponding to step (s21), (s24) and the like. Alternatively, it may be so arranged that the customer terminal 3 carries out either the processing for retrieving a semiconductor specification or the processing for retrieving package/assembly information.

As described above in detail, according to the embodiments of the invention, there are provided a method, a system and a program product for efficiently trading electronic products.

Additional advantages and modifications will readily occur to those skilled in the art. Therefore, the invention in its broader aspect is not limited to the specific details and representative embodiments shown and described herein. Accordingly, various modifications may be made without departing from the spirit or scope of the general inventive concept as defined by the appended claims and their equivalents.

What is claimed is:

1. A method for trading electronic products by transmitting/receiving electronic data by way of a communication network, the method comprising:
prompting an expected buyer of an electronic product to input a specification of the electronic product the expected buyer wants to buy;
extracting the electronic product which meets the specification of the electronic product from a database; and
outputting information of the electronic product to a manufacturer.

2. A method according to claim 1, further comprising:
simulating a condition for manufacturing the electronic product including at least one of performance, a manufacturing period, and a cost before outputting information of the electronic product; and
providing the expected buyer with the condition for manufacturing the electronic product to prompt the expected buyer to answer if the condition for manufacturing the electronic product is satisfied or not.

3. A method according to claim 2, wherein the condition for manufacturing the electronic product provided to the expected buyer is performance, and the method further comprising:
providing the expected buyer with at least one of the cost and the manufacturing period of the electronic product to prompt the expected buyer to answer if at least one of the cost and the manufacturing period of the electronic product is satisfied or not after receiving the answer from the expected buyer if the condition for manufacturing the electronic product is satisfied or not.

4. A method according to claim 1, further comprising:
prompting the manufacturer to provide an estimated result of the electronic product;
determining if an order of the electronic product to the manufacturer should be placed or not based on the estimated result which is received from the manufacturer; and
placing the order of the electronic product to the manufacturer if the determination indicates that the order of the electronic product to the manufacturer should be placed.

5. A method according to claim 1, further comprising:
prompting the manufacturer to provide an estimated result of the electronic product;
providing the expected buyer with the estimated result to prompt the expected buyer to transmit data which indicates that the expected buyer wants to place an order of the electronic product to the manufacturer or not based on the estimated result; and
placing the order of the electronic product to the manufacturer if received data from the expected buyer indicates that the expected buyer wants to place the order of the electronic product to the manufacturer.

6. A method according to claim 1, wherein the specification includes at least one of information to classify the electronic product, information which indicates performance of the electronic product, package information, assembly information, cost information, delivery date information, information which indicates an available environment to use the electronic product, and design information.

7. A method according to claim 1, wherein the electronic product is a semiconductor product.

8. A system for trading electronic products by transmitting/receiving electronic data by way of a communication network, the system comprising:
a first device configured to prompt an applicant who wants to buy an electronic product to input a specification of the electronic product the applicant wants to buy, and cause to extract the electronic product which meets the specification of the electronic product from a database; and
a second device configured to output information of the electronic product to a manufacturer.

9. A system according to claim 8, wherein the first device causes to simulate a condition for manufacturing the electronic product including at least one of performance, a manufacturing period, and a cost after causing to extract the electronic product from the database, and provides the applicant with the condition for manufacturing the electronic product to prompt the applicant to answer if the condition for manufacturing the electronic product is satisfied or not.

10. A system according to claim 9, wherein the condition for manufacturing the electronic product provided to the applicant is performance, and the first device provides the applicant with at least one of the cost and the manufacturing period of the electronic product to prompt the applicant to answer if at least one of the cost and the manufacturing period of the electronic product is satisfied or not after receiving the answer from the applicant if the condition for manufacturing the electronic product is satisfied or not.

11. A system according to claim 8, wherein the first device prompts the manufacturer to answer if the manufacturer can receive an order of the electronic product or not, determines whether the order of the electronic product to the manufacturer should be placed or not based on the answer which is received from the manufacturer, and places the order of the electronic product to the manufacturer if the determination indicates that the order of the electronic product to the manufacturer should be placed.

12. A system according to claim 8, wherein the first device prompts the manufacturer to answer if the manufacturer can receive an order of the electronic product or not and to provide an estimated result of the electronic product, provides the applicant with the estimated result to prompt the applicant to determine whether the applicant wants to place the order of the electronic product to the manufacturer or not based on the estimated result, and places the order of the electronic product to the manufacturer if received data from the applicant indicates that the applicant wants to place the order of the electronic product to the manufacturer.

13. A system according to claim 8, wherein the specification includes at least one of information to classify the electronic product, information which indicates performance of the electronic product, package information, assembly information, cost information, delivery date information, information which indicates an available environment to use the electronic product, and design information.

14. A system according to claim 8, wherein the electronic product is a semiconductor product.

15. A program product for causing a computer system to trade electronic products by way of a communication network, the program product comprising:
a first program code recorded on a recording medium and configured to assign the computer system a command for prompting an expected buyer of an electronic product to input a specification of the electronic product the expected buyer wants to buy;
a second program code recorded on the recording medium and configured to assign the computer system a command for extracting the electronic product which meets the specification of the electronic product from a database; and
a third program code recorded on the recording medium and configured to assign the computer system a command for outputting the information of the electronic product to a manufacturer.

16. A program product according to claim 15, further comprising:
a fourth program code recorded on the recording medium and configured to assign the computer system a command for simulating a condition for manufacturing the electronic product including at least one of performance, a manufacturing period, and a cost before outputting the information of the electronic product; and
a fifth program code recorded on the recording medium and configured to assign the computer system a command for providing the expected buyer with the condition for manufacturing the electronic product to prompt the expected buyer to answer if the condition for manufacturing the electronic product is satisfied or not.

17. A program product according to claim 16, wherein the condition for manufacturing the electronic product provided to the expected buyer is performance, and the program product further comprising:
a sixth program code recorded on the recording medium and configured to assign the computer system a command for providing the expected buyer with at least one of the cost and the manufacturing period of the electronic product to prompt the expected buyer to answer if at least one of the cost and the manufacturing period of the electronic product is satisfied or not after receiving the answer from the expected buyer if the condition for manufacturing the electronic product is satisfied or not.

18. A program product according to claim 15, further comprising:
a fourth program code recorded on the recording medium and configured to assign the computer system a command for prompting the manufacturer to provide an estimated result of the electronic product; and
a fifth program code recorded on the recording medium and configured to assign the computer system a command for determining if an order of the electronic product to the manufacturer should be placed or not based on the estimated result which is received from the manufacturer, and placing the order of the electronic product to the manufacturer if the determination indicates that the order of the electronic product to the manufacturer should be placed.

19. A program product according to claim 15, further comprising:
a fourth program code recorded on the recording medium and configured to assign the computer system a command for prompting the manufacturer to provide an estimated result of the electronic product; and
a fifth program code recorded on the recording medium and configured to assign the computer system a command for providing the expected buyer with the estimated result to prompt the expected buyer to transmit data which indicates whether the expected buyer wants to place an order of the electronic product to the manufacturer or not based on the estimated result, and placing the order of the electronic product to the manufacturer if received data from the expected buyer indicates that the expected buyer wants to place the order of the electronic product to the manufacturer.

20. A program product according to claim 15, wherein the specification includes at least one of information to classify the electronic product, information which indicates performance of the electronic product, package information, assembly information, cost information, delivery date information, information which indicates an available environment to use the electronic product, and design information.

21. A method for trading electronic products by transmitting/receiving electronic data by way of a communication network, the method comprising:
transmitting an retrieval program for retrieving an electronic product which meets a specification of the electronic product an expected buyer of the electronic product wants to buy to a terminal to prompt the terminal to start the retrieval program and transmit data which indicates a result of the retrieval including the specification of the electronic product;
receiving data which indicates the result of the retrieval including the specification of the electronic product; and
outputting information of the electronic product to a manufacturer based on the result of the retrieval.

22. A method according to claim 1, further comprising:
providing a designer with information of the electronic product to prompt the designer to provide an estimated result for designing the electronic product;
providing the expected buyer with the estimated result for designing the electronic product to prompt the expected buyer to transmit data which indicates that the expected buyer wants to place an order of the design of the electronic product to the designer based on the estimated result for designing the electronic product; and
placing the order of the design of the electronic product to the designer if received data from the expected buyer indicates that the expected buyer wants to place the order of the design of the electronic product to the designer.

23. A system according to claim 8, wherein the first device provides a designer with information of the electronic product to prompt the designer to provide an estimated result for designing the electronic product, provides the applicant with the estimated result for designing the electronic product to prompt the applicant to determine whether the applicant wants to place an order of the design of the electronic product to the designer or not based on the estimated result, and places the order of the design of the electronic product to the designer if received data from the applicant indicates that the applicant wants to place the order of the design of the electronic product to the designer.

24. A program product according to claim 15, further comprising:
a fourth program code recorded on the recording medium and configured to assign the computer system a command for providing a designer with information of the electronic product to prompt the designer to provide an estimated result for designing the electronic product; and
a fifth program code recorded on the recording medium and configured to assign the computer system a command for providing the expected buyer with the estimated result for designing the electronic product to prompt the expected buyer to transmit data which indicates whether the expected buyer wants to place an order of the design of the electronic product to the designer or not based on the estimated result, and placing the order of the design of the electronic product to the designer if received data from the expected buyer indicates that the expected buyer wants to place the order of the design of the electronic product to the designer.
